(19) United States
(12) Patent Application Publication
(10) Pub. No.: US 2002/0010649 A1
(43) Pub. Date: Jan. 24, 2002

(54) Lottery buying and selling system introducing real-time economic variable indexes

(76) Inventor: Sang-Rae Lee, Seoul (KR)

Correspondence Address: David A. Hall, Heller Ehrman White & McAuliffe LLP, 6th Floor, 4350 La Jolla Village Drive, San Diego, CA, 92122-1246, US

(21) Appl. No.: 09/898,651

(22) Filed: Jul. 3, 2001

(30) Foreign Application Priority Data
Jul. 4, 2000 (KR) 2000-38025

(51) Int. Cl. G06F 17/60

(52) U.S. Cl. 705/26

(57) ABSTRACT

Disclosed is a lottery buying and selling system introducing economic variable indexes. The system includes the steps of a consumer transmitting data in which at least one real-time economic variable index is inputted to a vendor's system, the vendor's system receiving the data from the consumer and creating a consumer record, the vendor's system judging a prize winning by comparing a confirmed economic variable index with the data of the consumer record after the lapse of a predetermined time period and performing an allotment according to a result of comparison, and the vendor's system transmitting a result of the allotment to a credit company system. Thus, the consumer group having professionalism can be widely secured, and the defects of the entertainingness and speculation can be minimized.

### BACKGROUND OF THE INVENTION

1. Field of the Invention

The present invention relates to a system for buying and selling lotteries constructed through a network, and more particularly to a lottery buying and selling system that introduces real-time economic variable indexes as the basis for deciding prize winning.

2. Description of the Related Art

Before the introduction of the Internet, a unique and typical type of lottery buying was that a consumer directly buys lotteries through a lottery store, convenience store, resting place, etc.

At present, as various kinds of purchases and sales are done via the Internet, a lottery buying and selling system constructed through a network has been developed. Though the lottery business in some countries has not yet been completely transferred to private hands, lottery buying systems (such as URL addresses: www.lottery.co.uk, lottery.yahoo.com, etc.), whereby a purchaser directly purchases lotteries composed of a combination of figures and/or Alphabet characters through a computer system network, or the purchaser inputs and transmits to a lottery-selling business his chosen numeral data and then prize winners are determined by drawing, have been developed and have been in commercial services in some countries. However, any one of such buying systems does not provide a service that introduces real-time economic variable indexes. Also, most of the lottery-selling business determine the prize winning using a card game such as jackpot, and this may cause a strong entertainingness and excessive speculations.

Except for the view of lottery buying and selling, there have been attempts to create demands on a network using economic variable indexes. For example, a service that provides a prize to a person who hits the stock price has been proposed. However, since this is generally an additional or extra service for promoting the purchase of main goods provided by a vendor and is considered as a mere event, thus it has basic limitations, and does not reach a main system introducing any economic variable index.

### SUMMARY OF THE INVENTION

Therefore, an object of the invention is to provide a new network system that introduces real-time economic variable indexes as main elements in a lottery buying and selling system.

The lottery buying and selling system according to the present invention has the following features in respect of business, process, and data structure model.

Business

The feature of the present invention in business lies in the fact that the lottery buying and selling is systematically combined with real-time economic variable indexes.

Real-time economic variables are all indexes in close connection with real economic conditions which vary with the lapse of time such as a stock price index, Nasdaq index, Kosdaq index, exchange rate, future index, etc. It is needless to say that these indexes themselves considerably affect or reflect the economic conditions, and thus it has become a daily work of many businessmen to estimate their variations and determine whether to make an investment. According to the present invention, a consumer establishes at least one of the economic indexes determined based upon his/her own experience as a lottery, and a vendor as a lottery-selling business confirms or identifies the prize winning based on the objective economic indexes automatically confirmed after a predetermined time and makes corresponding allotments thereto.

The lottery buying and selling system of the present invention can encourage consumers to actively take part therein, and since the consumer determines the indexes based upon his/her own expert experience and knowledge, the speculative defects caused by the dependence on fortune only can be minimized. Also, since winning chance of hitting the index mainly depends on the consumer's economic index estimation ability, the corresponding allotment is on the consumer's own responsibility, and thus it can greatly heightens the participation of the consumer group having professionalism.

Also, according to the present invention, considering the difficulty of estimating the economic variable indexes having great variation widths at all times, if no customer has entered the accurate index, the lottery having the most approximate estimation value is determined as the prize winning, so that the burden imposed on the participant can be greatly reduced and the economic allurement effect can be increased.

Also, according to the present invention, the allotment is uniformly made to the consumers who bought the lotteries over a predetermined number of times, and this causes the secession of the customers from the market to be minimized and the continuous demand to be maintained.

The system according to the present invention is designed to have an independent URL address, and thus linked to financial agencies of many banks and security companies and to web pages of auction and shopping agencies. In this case, the consumer's positive anticipation and the activation of business can be greatly increased in addition to the above-described advantages.

Process

Though the buying and selling of lotteries are performed on the network, it is necessary that the consumer opens an account with a credit company such as a bank in order to confirm allotments from the vendor and buy lotteries. This settlement system can be replaced by a credit card or e-money system.

The realization of lotteries is effected in a manner that the consumer sends to the vendor the data of the economic variable indexes inputted through his computer, and the vendor system recognizes the data in appropriateness, and writes the data in consumer records. Also, the realization of lotteries can be performed in a manner that the consumer sends the economic variable indexes to the vendor's system using a wire phone or cellular phone.

The vendor's system judges the prize winning by searching the consumer's records based on the economic variable index automatically confirmed after the lapse of a predetermined time. The prize winning generally occurs if the confirmed index coincides with the consumer's input data. However, if no data coincides with the confirmed index as a result of comparison, the system judges the consumer's record having the data most approximate to the confirmed index as the-prize-winning record.

The allotment is made with respect to all the records referring to the allotment money recorded in an allotment table. If two or more prize winnings are found, equal amount of money obtained by dividing the allotment money by the number of prize winning records is allocated to the each winner.

The vendor's system creates allotment records corresponding to the respective consumer's records with reference to the consumer database. In the created allotment record are entered the data inputted by the consumer and the result of allotment, and this allotment record is sent to the system of the respective credit company. For example, in case of a bank, the result is outputted to and printed in the bankbook opened by the consumer through the banker's system, and thus the consumer can confirm his/her prize winning and allotment results. The result of the prize drawing and allotment may be also provided on the web page of the vendor.

In addition to the above-described prize wining methods, i.e., search of data in coincidence with or the most approximate to the confirmed index, the present invention introduces two more prize-winning processes.

First, one method is to calculate deviation values between the data inputted by the consumer and the confirmed economic variable indexes for a predetermined time, and to judge the prize-winning grades in the order of the deviation value, i.e., from the smallest deviation value to a specified value. For example, in case that the economic variable index is the stock price index, the deviation value between the confirmed stock price index and the stock price index inputted by the consumer is accumulatively calculated with respect to the consumer record that has been inputted on Tuesday, Wednesday, Thursday, and Monday. Then, from the record having the lowest accumulated value to the record having a predetermined value, for example, the value corresponding to the 20^{th} grade, are judged to be the prize winning, so that the allotment is performed accordingly.

Second, the other method is to count the number of lottery purchase of a consumer, and if it is searched that the counted value coincides with the predetermined number of times, then judge the corresponding record to be the prize winning to perform uniform allotment. For example, if the number of lottery purchase reaches 20, all the corresponding consumer records are judged to be the prize winning irrespective of the coincidence/non-coincidence with the economic variable index, and allotment is performed uniformly to the chosen data.

Another feature of the present invention in process is to enable the consumer to input at least two or more economic variable indexes. In this case, the record is judged to be the prize winning and the corresponding allotment is performed (1) if two or more indexes inputted by the consumer coincides with the confirmed indexes in all, (2) if one of indexes inputted by the consumer coincides with the corresponding confirmed index, or as an exception of case (2), (3) if the respective index is most approximate to the corresponding confirmed variable economic index. For example, if the economic variable indexes are the stock price index and the exchange rate on US dollar purchase, the record having both the exact indexes is judged to be the first-grade prize winning, and the record having a data that coincides with either of the two indexes is judged to be the second-grade prize winning. In the latter case, if no coincident data is found, the record having the most approximate data is searched and judged to be the second-grade prize winning.

In case that the first-grade prize winning is not searched, the corresponding amount of allotment is added to the allotment table, and then used as the allotment basis to the next time. Since the respective economic variable indexes have different meanings in its property, it should be noted that if the first-grade prize winning does not exist, the data having the smallest accumulated value obtained by adding the deviations from the respective different indexes cannot be used as a reference data for deciding prize drawing. That is because even a small deviation, for example, of 0.1, have different meanings in stock price index and exchange rate.

In case that the number of the economic variable indexes is two or more, the other processes are basically identical to that for one economic variable index except for the case (1) as described above. Accordingly, (A) the prize winning process that calculates the accumulated deviation value from the respective economic variable indexes, and (B) the uniform allotment process for the records having the counter value that reaches a predetermined number can be equally applied.

Data Model

The vendor's system is provided with the data model according to the present invention, and comprises of a consumer record, consumer database, allotment table, and allotment record database.

First, each field of the consumer database includes a consumer ID field and credit company field. In the consumer ID field are entered, for example, consumer-related terms such as a secret number for identifying the competent consumer for the vendor, resident registration number, etc., and in the credit company field are entered a correspondent band and bank account number, or respective inherent codes in case of e-money or credit card.

Each field of the consumer record includes a consumer ID, input date, array of at least one economic variable index, and counter. To each economic variable index field is added a sub field for entering the deviation value from the confirmed economic variable index. The counter field is for accumulatively calculating and entering the number of lotteries that has been bought by the consumer.

In the allotment table are entered respective amounts of allotment according to the respective prize winning grades. The amount of allotment may be of a fixed type, or different amounts of allotment may be given to the respective prize winning grades according to the total amount of lottery sale. In the latter case, the total amount of allotment is determined as the value obtained by multiplying the total amount of purchase by a predetermined percentage, and the final amounts of allotment are determined as the values obtained by respectively multiplying the total amount of allotment by predetermined rates according to the respective prize winning grades.

The allotment record includes data to be transmitted to the system of the credit company, and is created as many as the number corresponding to the consumer records. This record comprises a consumer ID, credit company field, input date, at least one economic variable index array where the data inputted by the consumer is entered, amount of allotment, and reference field.

The vendor system searches and locates data having the same credit company code number, and transmits the corresponding records to the system of the credit company. In case that the credit company is a bank, the economic variable index array, amount of allotment, and reference field are finally printed on the bankbook. The system of the credit company operates separately from the vendor system, and thus does not relate to the subject matter of the present invention.

According to the present invention, in addition to the basic data model as described above, a prize winning record and/or accumulated deviation value storage database for transmitting related data to the allotment record is created as a temporary file.

The data model may be freely changed within the limit of the achievement of the business and process according to the present invention. For example, it is possible to omit the allotment record by adding its fields to the consumer record.

Hereinafter, a preferred embodiment of the present invention will be explained with reference to general economic variable indexes, and especially, for the convenience of understanding, with reference to the stock price index and Nasdaq index.

### BRIEF DESCRIPTION OF THE DRAWINGS

The above object, and other features and advantages of the present invention will become more apparent after a reading of the following detailed description when taken in conjunction with the drawings, in which:

FIG. 1 is a view illustrating a whole lottery buying and selling system according to the present invention;

FIG. 2 is a block diagram illustrating the construction of a vendor system according to the present invention;

FIG. 3 is a flowchart illustrating an example of consumer record process according to a typical prize winning type according to the present invention;

FIG. 4 is a flowchart illustrating an example of the grade confirmation and allotment process for selected records in FIG. 3;

FIG. 5 is a flowchart illustrating an example of the prize winning and allotment type by accumulated deviation calculation according to the present invention;

FIG. 5 is a flowchart illustrating an example of the prize winning and allotment type by counter calculation according to the present invention; and

FIG. 7 is a view illustrating an example of a database model constituting the vendor system according to the present invention.

### DETAILED DESCRIPTION OF THE PREFERRED EMBODIMENT

Hereinafter, the construction and effect of the present invention will be described with respect to a preferred embodiment illustrated in the annexed drawings.

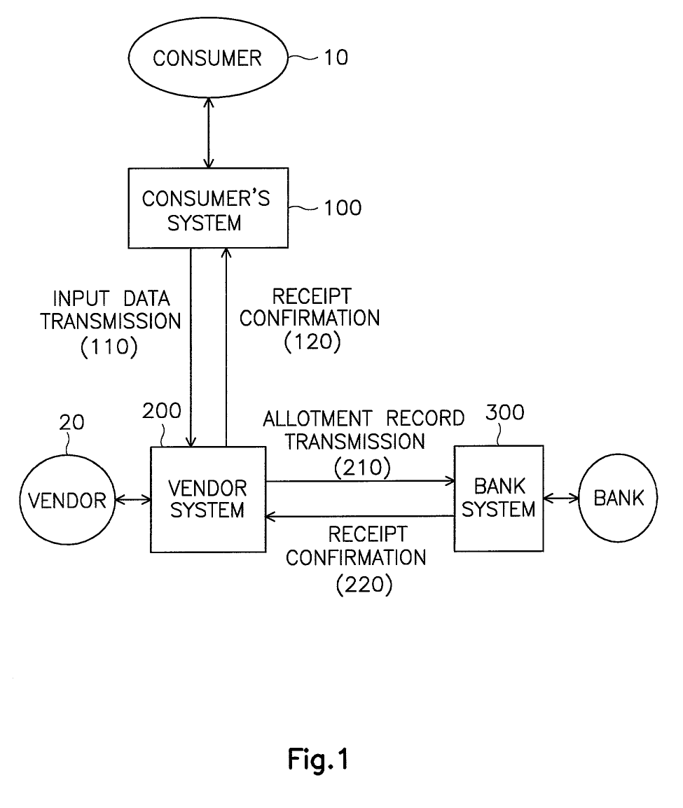

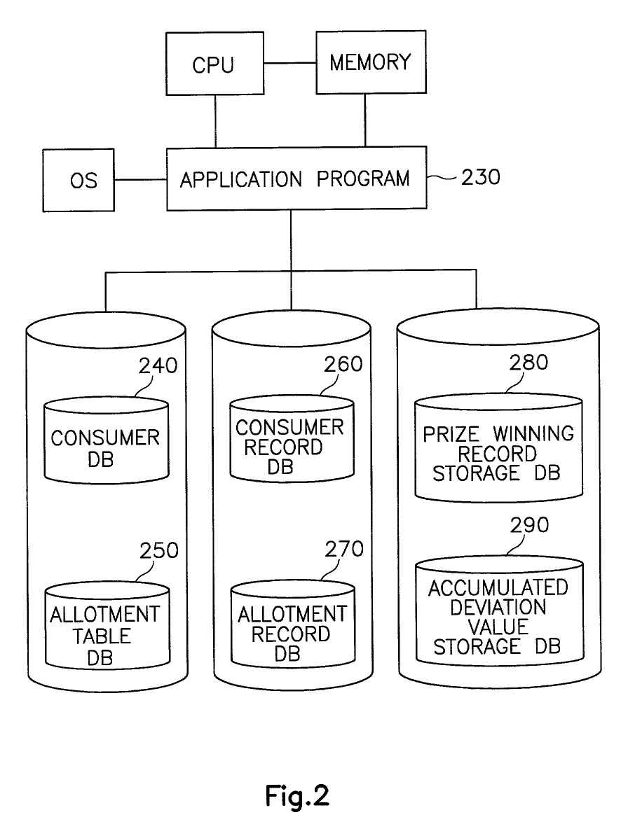

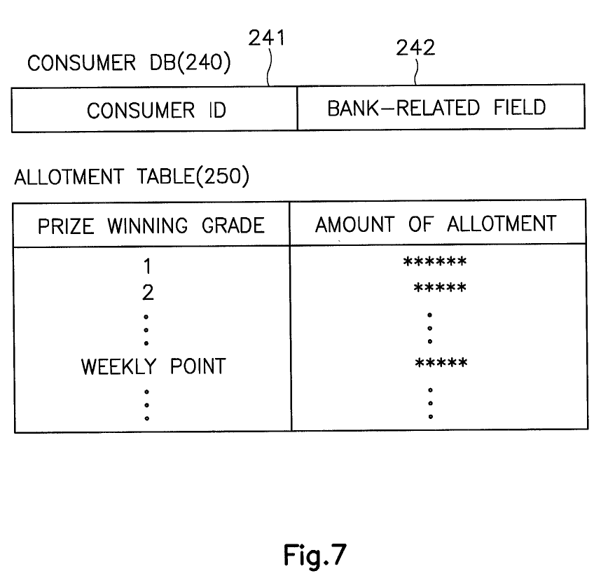

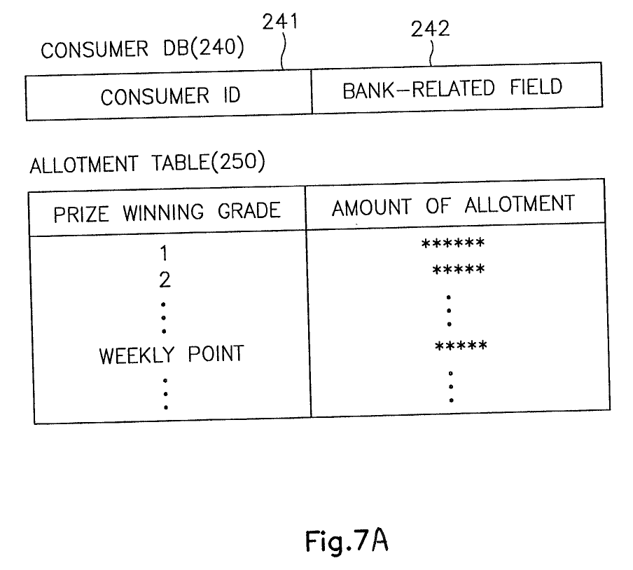

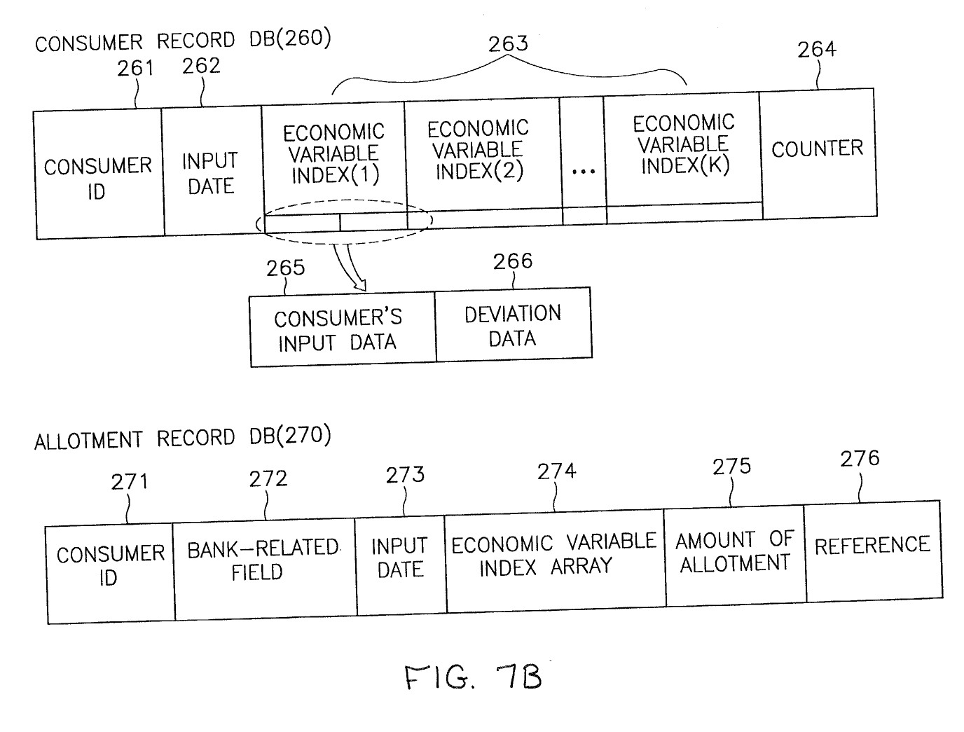

FIG. 1 is a view illustrating the whole lottery buying and selling system according to the present invention, and FIG. 2 is a block diagram illustrating the construction of the vendor system 200. FIG. 7 is a view illustrating an example of a database model of FIG. 2.

The system according to the present invention comprises a consumer's system 100, vendor system 200, bank system 300, and consumer 10, vendor 20, and bank 30 as respective managers. The system can be constructed on the Internet-based unified network. The consumer's system 100 for connecting with the vendor system 200 comprises a communication appliance such as a wire phone, cellular phone, etc. as well as a computer.

The consumer's system 100 transmits to the vendor system 200 the economic variable indexes inputted by the consumer, such data as the stock price index and/or the Nasdaq index. The vendor system 200 judges whether the consumer is a regular member with reference to the consumer DB 240, and if there exists no error, creates a consumer record 260 based upon the received data and the consumer DB. The vendor system 200 then transmits a receipt-confirming message 120 to the consumer's system 100 to complete the lottery buying procedure.

The vendor system 200 transmits to the bank system 300 an allotment record 270 created after prize winning and allotment processes, and the bank system 300 transmits a receipt-confirming message 220 to the vendor system 200. The bank system 300 prints on the bankbook opened by the consumer 10 lottery buying date, input economic variable index, net amount of allotment, and reference data (prize winning grade and reason of allotment) with reference to the allotment record 270.

FIG. 2 shows the construction of the vendor system 200 according to the present invention. The vendor system 200 comprises an application program 230 operated by a central processing unit (CPU) and a memory to manage the whole system, a consumer DB 240 for storing consumer-related information such as a secret number, resident registration number, correspondent bank, and account number, allotment table 250 wherein amounts of allotment to be distributed are recorded, consumer record DB 260 created whenever the consumer buys the lottery via data transmission, and allotment record DB 270 for mainly recording results of prize winning and net amount of allotment.

The structure of the database of FIG. 2 will now be explained in detail with reference to FIG. 7.

The consumer DB 240 and the allotment DB 250 are databases basically held by the vendor system 200 before the prize winning process is performed. The consumer DB 240 comprises a consumer ID field 241 and a bank field 242, and basically holds the data of competent members registered in the vendor system 20. In the allotment table 250 are entered amounts of allotment according to the respective prize winning grade. The amounts of allotment may be fixed for each grade. However, in case that the allotment is differently made according to the total amount of lottery purchase, the total amount of allotment is determined by the value obtained by multiplying the total amount of purchase for a day by a predetermined percentage, and the respective amounts of prize winning are determined by respectively multiplying the total amount of allotment by predetermined percentages. Thus determined values are written in the allotment table 25.

The consumer record DB 260 and the allotment record DB 270 are data created whenever the prize winning process is performed. The consumer record DB 260 comprises fields of consumer ID 261, input date 262, economic variable index array 263, and counter 264. The economic variable index array takes values of 1 and 2 if the variable indexes are two, i.e., the stock price index and the Nasdaq index. Also, in the economic variable index array field is provided a data field 266 for writing the deviation value between the economic variable index confirmed and the data inputted by the consumer in addition to the data field 265 for recording the data transmitted from the consumer. For example, if the Nasdaq index inputted by the consumer is 3000.00, and the confirmed index is 3002.00, the numeral value of 3000.00 is written in the field 265, and the numeral value of 2.00 is written in the field 266. The reason why the deviation value is recorded is as follows. First, after the lapse of a predetermined time (for example, one week), accumulated data having the accumulated deviation values that are most approximate to the stock price indexes during this period are sequentially selected and judged as the prize winnings. Second, if no data that hits the stock price index of the corresponding day of the week exists, the record having the most approximate data is searched from the deviation value data and judged as the prize winning. Also, in the counter 264, 1 is added to the field whenever the lottery is bought, and the added data is written therein.

The allotment record DB 270 comprises a consumer ID created based on the consumer DB 240, bank-related data field 272, input date 273 created based on the consumer record DB 260, economic variable index array 274, amount of allotment 275 and reference data field 276 for accommodating the data transmitted from the prize winning record storage DB 280 and/or accumulated deviation value storage DB 290. It is preferable that all the fields except for the data fields 275 and 276 are created simultaneously with the creation of the consumer record DB 260. Also, in the reference data field, the reason of allotment, for example, data of “first grade prize winning”, “second grade prize winning”, “weekly accumulated value prize winning”, etc., is entered.

In FIG. 2, the prize winning record storage DB 280 is a database for storing only the prize winning record, and is used for the determination of the prize winning grade and the corresponding allotment. The accumulated deviation value storage DB is used for temporarily storing the sum of deviation values between the confirmed economic variable indexes and the data inputted by the consumer.

The DB model of FIGS. 2 and 7 is described as an example, and it can be freely changed within the limit of achieving the object of the present invention.

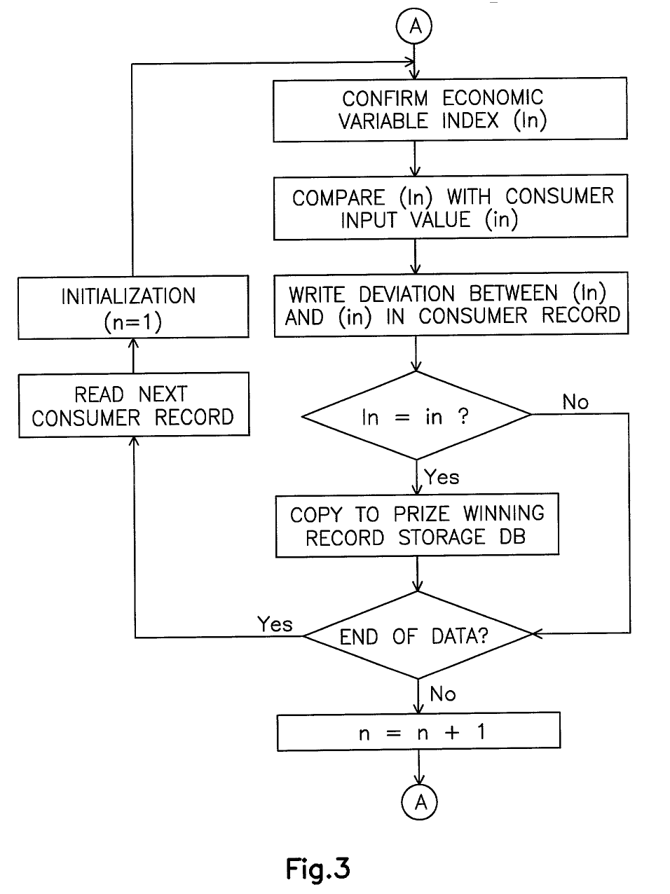

Next, the prize-winning determination and allotment process performed by the vendor system 200 will be explained in detail with reference to FIGS. 3 to 7.

FIG. 3 shows a flowchart illustrating the process of selecting only the prize-winning records. This process is performed with respect to one consumer record, and is repeatedly performed with respect to other remaining records.

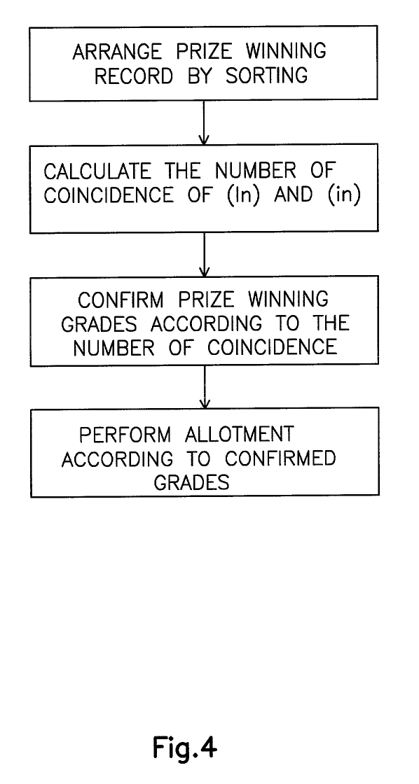

First, the vendor system 200 confirms the economic index In. If the closed stock price index on the day is 11500.00, and the Nasdaq index is 3000.00, it is defined that I1=11500.00, and I2=3000.00. Then, the economic variable index I1 is compared with the first value i1 of the economic variable index array of the first record in the consumer record DB 260, for example, the stock price index inputted by the consumer, and its deviation value is recorded in the field 266. Thereafter, if I1=i1, it is judged that the consumer wins a prize, and the corresponding record is copied to the prize winning record storage DB. Meanwhile, if I1≠i1, or after the record subject to the prize winning is copied, the prize winning process is again performed with respect to the same record by comparing the next economic variable index I2, for example Nasdaq index with the array data i2. If all the economic variable indexes are compared with the array values, respectively, the same process are repeated with respect to the next consumer record. All the records judged to be the prize winning are entered in the prize winning record storage DB 280, and then with respect to these records, the grade-deciding process is performed as shown in FIG. 4.

The process of FIG. 3 is an example of judging the prize winning by sequential reading of a record, and another process of selecting the prize winning records by comparing all the consumer data based on the respective economic variable indexes can also be considered.

Next, referring to FIG. 4, the prize-winning records are inter-related and arranged as one record in relation to the records having the same consumer ID field, input date, and counter. This is because in the prize winning record storage DB 280, the records of the same lottery by the same consumer, i.e., the record that hits the stock price index and the record that hits the Nasdaq index, are separately written with no relation to each other. Thereafter, the number of coincidence of the economic variable indexes In and the array data in is calculated. Then, the prize winning grades are determined in a manner that if they coincide with each other without exception, the first-grade prize winning is given, while one of them hits only once, the second-grade prize is given. Then, the corresponding amount of allotment calculated with reference to the allotment table 250 is entered in the allotment amount field that is added to the respective record in the prize winning record storage DB 280.

The data of the coincidence number and the data of the allotment amount in the prize winning record storage DB 280 are moved to the allotment record 270 by searching the same consumer ID. Here, it is preferable that the data of the coincidence number is converted into a message for outputting a note of explaining the result of the allotment process.

Meanwhile, with respect to the consumer record that gets no prize winning in any case, no corresponding record is created in the prize winning record storage DB 280, and for example, 0 is entered in the allotment amount field of the allotment record 270.

The allotment record DB 270 created as above are transmitted to the bank system 300 to complete the prize winning and allotment process.

As described above, the case that the consumer record hits both the stock price index and the Nasdaq index and the case that the consumer record hits one of the indexes are exemplified. Other cases will be processed as follows.

If there exists no data that hits both the two kinds of indexes, it is determined that the first-grade prize winning is not given, and the first-grade allotment amount is increased for the next day's winner by adding the reserved allotment amount to the allotment amount of the next day. At this time, if there exists no first-grade prize winning for a predetermined time period, for example, for a week, it is preferable that the first-grade allotment amount accumulated for that time period is uniformly distributed to the second-grade allotment amount.

As for second-grade price winning, if there exists no consumer record that hits the stock price index or the Nasdaq index, the record having the most approximate data is judged to be the second-grade prize winning. This can be rapidly and accurately performed by searching the deviation values 266 in the consumer record DB 260 at the process of FIG. 3 as described above. In this case, there might be always two second-grade prize winning records.

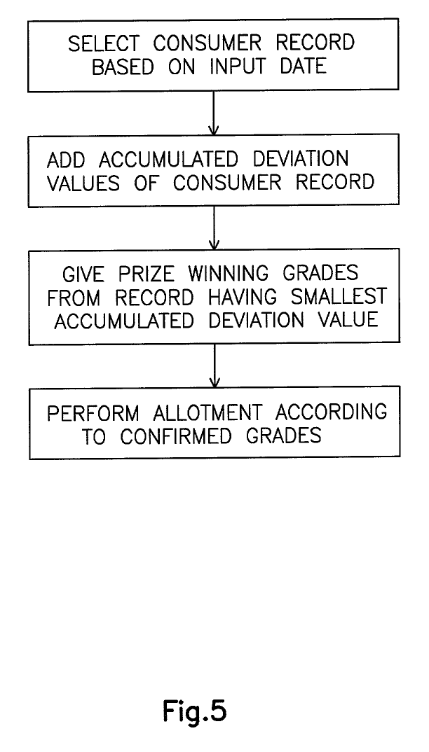

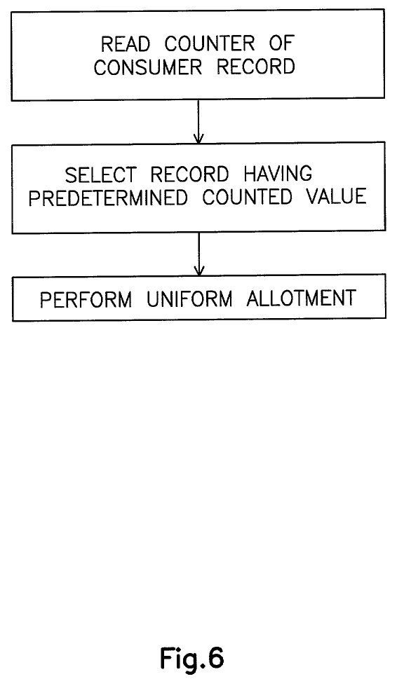

The process of the present invention that uses the typical prize winning method has been explained, and the present invention further performs separate allotments to the selected records by calculating the accumulated deviation value between the economic variable index and the data inputted by the consumer for a predetermined time period, and this process will now be explained with reference to FIG. 5.

First, all the records that a consumer has inputted at least once on all the days of the corresponding time period are selected from the consumer record DB 260 with respect to the same consumer ID 261 by searching the input date 262. For example, on the basis of the stock price indexes of Tuesday, Wednesday, Thursday, Friday, and Monday, the records of the consumer who has bought lotteries at least one or more on all these days are selected, and in this case, at least 5 records should be found with respect to the same consumer. Thus, the consumer who did not buy a lottery only on Tuesday, cannot expect the advantage of this process.

Next, the deviation value 266 of the consumer record DB 260 is accumulatively calculated based on the selected record, and the result is written in the accumulated deviation value storage DB 290. Here, in case that the same consumer bought lotteries two times or more in a day, only the deviation value of the data most approximate to the confirmed economic variable index among the records of the same day is calculated and accumulated. Also, in order to heighten the probability of prize winning, it is preferable that the accumulated values are added together except for the data having the largest deviation value, for example, the date of Friday.

If the process is completed with respect to all the selected consumer data, the prize-winning records in the order of the deviation value, i.e., from the record having the smallest deviation value to the record having a specified value, are selected based on the accumulated deviation value storage DB 290, and the allotment is performed accordingly with reference to the allotment table. The amount of allotment becomes smaller as the accumulated value becomes larger.

In case that the number of economic variable indexes is two or more, the same process as explained above is repeatedly performed with respect to the next index.

The allotment record 270 is created based on the accumulated deviation value storage DB 290, consumer record DB 260, and consumer DB 240. In the economic variable index array of the allotment record 270 is entered a blank, and in the reference field is entered, for example, a message of “prize winning of weekly point.”

Also, it is possible that a separate allotment is performed with respect to the consumers having the deviation value between the stock price index and the input index of less than, for example, “30”, and in this case, the prize winning and allotment process is substantially the same as that as described above.

Further, according to the present invention, in case that the consumer bought lotteries for a predetermined number of times, an extra and uniform allotment is performed. As shown in FIG. 6, this process is performed through the readout of the counter field 264 of the consumer record DB 260. The counter of the record for which the allotment was completed is set to 0, and becomes 1 when the consumer record DB is created by the consumer's next purchase of lottery.

Since the above-described accumulated value allotment process and the counter search process are performed in parallel with the typical prize winning process, it is possible to expect the first-grade or second-grade prize winner also benefits from these processes.

In addition, the result of prize winning and allotment according to the lottery buying and selling system of the present invention is not only transmitted to the bank system 300 but also open to the public on the web page of the vendor system 20. Thus, the fairness and reliability can be greatly improved.

As described above, since the present invention provides a system constructed by systematically combining the real-time economic variable indexes with the lottery buying and selling, the consumer group, especially the consumer group having professionalism can be widely secured, and the defects of the entertainingness and speculation can be minimized. Also, a separate allotment is performed with respect to the lottery-buying consumer whose record has the value approximate to the real economic variable index for a predetermined time period and/or who bought lotteries over the predetermined number of times, it is expected to heighten the above advantageous effects.

While this invention has been described in connection with what is presently considered to be the most practical and preferred embodiment, it is to be understood that other modifications, additions, and substitutions thereof may be made without departing from the scope of the invention.

What is claimed is:

1. A method for buying and selling lotteries wherein a consumer system, a vendor system, and a credit company system is connected via computer network system, comprising the steps of:
transmitting a consumer input data having at least one real-time economic variable index to a vendor's system;
receiving said data from the consumer and creating a consumer record at said vendor's system;
judging a prize winning by comparing a confirmed economic variable index with the data of the consumer record after lapse of a predetermined time period, and performing an allotment according to the result of said comparison; and
the vendor's system transmitting the result of said allotment to a credit company system.

2. The method as claimed in claim 1, wherein the vendor's system judges the prize winning when the confirmed economic variable index coincides with the data of the consumer record.

3. The method as claimed in claim 1 or 2, wherein the data of the consumer record and the confirmed economic variable index include at least two economic variable indexes.

4. The method as claimed in claim 3, wherein the vendor's system compares at least two confirmed economic variable indexes with the data of the consumer record, respectively, and differently perform the allotment according to the number of coincidence obtained as a result of said comparison.

5. The method as claimed in claim 3, wherein if at least two confirmed economic variable indexes do not coincide with the data of the consumer record in all as a result of comparison, the vendor's system judges no prize winning, and adds up a corresponding amount of allotment.

6. The method as claimed in claim 1 or 2, further comprising the step of the vendor's system comparing the confirmed economic variable index with the corresponding data of the consumer record, respectively, and if they do not coincide with one another, the vendor's system judging the data most approximate to the confirmed economic variable index to be the prize winning.

7. The method as claimed in claim 1, wherein the vendor's system calculates deviation value obtained by comparing the confirmed economic variable index with the data of the consumer record, and stores the result of said calculation.

8. The method as claimed in claim 1 or 7, further comprising the steps of the vendor's system calculating an accumulated value of the deviation value for a predetermined time period, and differently performing the allotment in the order of the accumulated value, starting from the smallest value.

9. The method as claimed in claim 1 or 7, further comprising the step of the vendor's system calculating an accumulated value of the deviation value for a predetermined time period, and if the accumulated value is less than a predetermined value, the vender's system judging the prize winning and performing the allotment.

10. The method as claimed in claim 1, further comprising the step of the vendor's system performs a uniform allotment if the number of lottery purchase of the consumer coincides with a predetermined number.

11. The method as claimed in claim 1, wherein the transmission of the consumer's data to the vendor's system is performed by connection with a wire phone or cellular phone.

12. The method as claimed in claim 1, wherein the real-time economic variable index is one among a stock price index, Nasdaq index, exchange rate, and future index.
